(19) United States
(12) Patent Application Publication
(10) Pub. No.: US 2003/0109814 A1
(43) Pub. Date: Jun. 12, 2003

(54) Apparatus for promoting nerve regeneration in paralyzed patients

(76) Inventor: Patrick D. Rummerfield, O'Fallon, IL (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/252,218

(22) Filed: Sep. 23, 2002

Related U.S. Application Data
(60) Provisional application No. 60/323,828, filed on Sep. 21, 2001.

(51) Int. Cl. A61H 1/00; A61H 3/00

(52) U.S. Cl. 601/5; 601/24; 601/36

(57) ABSTRACT

The present disclosure provides a method of rehabilitating a person who has suffered spinal cord damage comprising the steps of: 1) providing exercise equipment capable of exercising a person's limbs, 2) providing functional electrical stimulation to the person's limbs to be exercised in order to operate the exercise equipment, 3) reducing the level of functional electrical stimulation as the person's muscles tire, 4) decreasing a resistance provided by the exercise equipment or providing assistance to maintain an acceptable speed of the exercise equipment, and 5) completely removing functional electrical stimulation to the person's limbs and providing assistance to maintain an acceptable speed of the exercise equipment.

### TECHNICAL FIELD

The present invention relates generally to apparatus for the promotion of nerve regeneration in paralyzed patients. More specifically, it relates to an apparatus that promotes nerve regeneration by combining active and passive exercise of the patient's disabled limbs.

### BACKGROUND OF THE INVENTION

More than one-quarter of a million people currently have impaired use of their limbs due to injuries to their nervous systems. This impaired limb use, besides creating mental and physical challenges to the patient also can generate muscular atrophy, loss of bone mineral content, decubitus ulcers, urinary tract infections, muscle spasticity, impaired circulation, and reduced heart and lung capacity. Generally, impaired use is a result of a spinal injury or stroke, but can be the result of a number of conditions.

In the past, exercise for paralyzed individuals consisted of moving the patient's limbs passively in order to avoid the problems of impaired limb use. Typically, a therapist would manipulate the patient's limbs manually. However, passive exercise does induce as much blood flow or reduce muscle atrophy enough to fully avoid the problems associated with paralyzed limbs.

As result, systems were developed that utilized functional electrical stimulation to directly induce the muscles in a paralyzed limb to contract in order to perform exercise. As these systems improved, active exercise became the preferred method of exercising a paralyzed patient's limbs.

However, active exercise using functional electrical stimulation is generally used only until the muscle becomes tired. After the muscle tires, conventionally therapy is concluded, and the muscle is allowed to rest. We have unexpectedly discovered that continuing movement of the impaired limb using passive stimulus after discontinuing functional electrical stimulation promotes nerve regeneration in the affected area of the nervous system. In order to continue movement of the limb after the muscles tire, functional electrical stimulation is reduced or discontinued and passive exercise is initiated. By passively moving the affected limbs by mechanical means memories of control of the limbs are “remembered” by the nervous system As a result, individuals with paralyzed limbs are able to gain some control of the paralyzed limb.

### BRIEF DESCRIPTION OF THE DRAWINGS

FIG. 1 is a side view of a bicycle for a paralyzed patient according to an embodiment of the present invention; and

FIG. 2 is a side view of a gate trainer for a paralyzed patient according to an embodiment of the present invention

### DETAILED DESCRIPTION OF THE PREFERRED EMBODIMENT

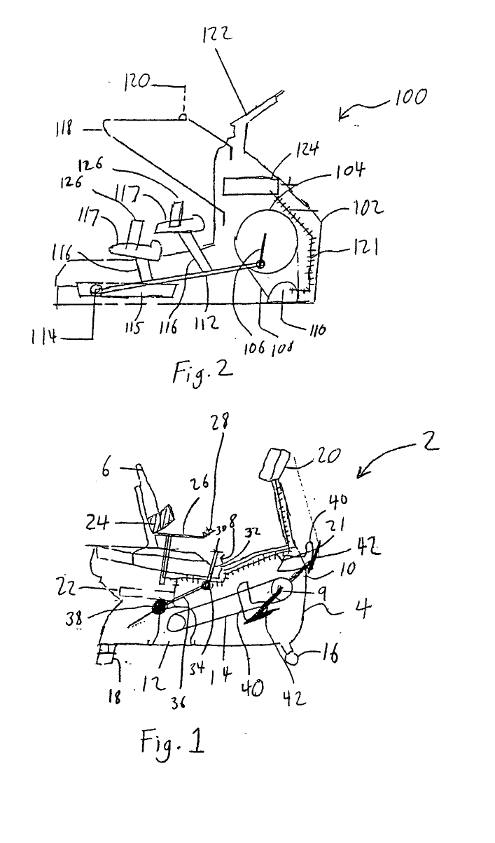

Referring to FIG. 1, there is provided an active/passive stimulation exercise trainer 2. The trainer 2 comprises a frame portion 4 to which is attached a seat 6, a pair of adjustable leg braces 8, a pulley or sprocket 9, crank arms 10 connected to the sprocket 9 and an electric motor 12 also connected to the sprocket 9 by a belt or chain 14. The frame portion 4 is maintained in an upright position by outwardly extending front and rear feet 16, 18. Also attached to the frame 4 is a bike control and readout (BCR) computer 20 attached to a functional electrical stimulation (FES) computer 22, the electric motor 12, and a control pad 28 by a cable 21. The FES computer 22 is a known device for electrical stimulation of muscles to induce organized contractions in order to move a patient's limbs. FES computers 22 are known and available from a variety of sources. The BCR computer 20 tracks stimulation current and cycle RPM and displays motor resistance, stimulation current, miles, total revolutions and RPM.

Attached to the seat 6 are a trunk support 24 and a seat belt (not shown) for providing additional support for a paralyzed patient. Also attached to the seat 6 and frame portion 4 is an armrest 26 and the control pad 28. The control pad 28 has an emergency stop button, a speed control dial or button and a start button. It is also contemplated that mounted to the control pad 28 or the BCR 20 is a microphone for receiving speech commands from the patient or therapist to be processed by the BCR computer 20 for controlling the trainer 2.

Each of the leg braces 8 has a leg support portion 30 attached to a first rod 32 that is extendable from a first clamp 34. Also attached to the first clamp 34 is a second rod 36 that is extendable from a second clamp 38. The second clamp is attached to the frame portion 4. By loosening the clamps 34, 38 and sliding the rods 32, 36 within the clamps 34, 38 and retightening the clamps 34, 38, the leg brace 8 can be adjusted to support patients of different sizes. Additionally it is contemplated that the seat 6 back can also be adjusted to support patients of different sizes. Finally boots 40 are attached to pedals 42 positioned on the ends of the crank arms 10 to fasten a patient's foot to the crank arms 10.

In operation, a paralyzed patient is seated on the chair 6 and is held by a seat belt. The patient's feet are attached to the boots 40 and the FES computer 22 is attached to the patient to begin electrical stimulation of the patient's muscles. Once FES begins, the patient's muscles begin to rotate the crank arms 10. The rotating crank 10, in turn, rotates the electric motor 12 through the chain 14. Initially, the motor 12 operates in a brake mode in order to provide resistance to the patient's muscles. The BCR computer 20 monitors the motor 12 rotation speed and controls the brake force of the motor 12 to maintain a desired RPM. As the patient's muscles begin to tire, less brake force will be required to maintain the desired RPM until, at some point, the motor 12 will switch from a brake mode to a motor mode whereby the motor 12 is providing the power required to either assist the tired muscles in rotating the crank 10 (i.e. with full or reduced FES) or to continue rotating the crank 10 in the absence of assistance from the patient's muscles (i.e. in the absence of FES). We have found that utilizing passive exercise after FES is discontinued causes nerve regeneration in the patient.

Referring to FIG. 2, there is shown a gate trainer exercise machine 100. The gate trainer exercise machine 100 simulates the act of walking for a patient. To that end, there is provided a gate trainer frame 102 on which a flywheel 104 is mounted. Opposed crank arms 106 are attached to the flywheel 104. Connected to the flywheel 104 by a belt or chain 108 is an electric motor 110. First ends of two translational motion shafts 112 are connected to the crank arms 106 on either side of the flywheel 104. Rollers 114 are attached to the opposite ends of the translational motion shafts 112.

The gate trainer frame 102 defines two slots 115 on opposite sides of the frame 102 in which the rollers 114 are trapped. The rollers 114 move along the slots 115 in translational motion with the slots 115. Also attached to each translational motion shaft 112 is a foot support rod 116 and a foot support 117. A handrail 118 is attached to the gate trainer frame 102 and has a control pad 120 with an emergency stop button, a speed control dial or button and a start button. Also attached to the frame 102 is a gate trainer control and readout (GTCR) computer 122 that is attached to a FES computer 124, the electric motor 110, and the control pad 120 by a cable 121. The GTCR computer 122 tracks stimulation current and crank or motor RPM and displays motor resistance, stimulation current, miles, total revolutions and RPM.

It is also contemplated that each foot support 117 can be height-adjustable. This can be accomplished in numerous ways, for example by providing two telescoping rods having holes drilled therethrough in place of each foot support rod 116. To maintain the two telescoping rods in the proper relationship a pin can be inserted through the holes of the rods.

The gate trainer exercise machine 100 is operated by lifting a paralyzed patient in an overhead hoist (not shown) that supports the patient's torso and allows the patient's legs to be moved freely. The patient is placed over the foot supports 116 and the patient's feet are strapped to the foot supports 116 using foot straps 126. Once the patient is in position, the motor 110 begins rotating thereby turning the flywheel 104. The flywheel 104, in turn, rotates the crank arms 106. The rotational motion of the crank 106 is then converted to translational motion by the translational motion shafts 112 and the rolling of the rollers 114 within the slots 115. However, there is also an up-and-down motion to the translation motion shafts 112 as the translational motion shafts 112 rotate with the crank 106 using the rollers 114 as a center point. The elliptical motion created by the translational motion shafts 112 is thus similar to the lifting and then stepping of a person's feet while walking.

When the patient first begins using the gate trainer exercise machine 100, FES is used to stimulate the patient's muscles in order to cause the patient to simulate walking. The motor 110 is run in a brake mode to provide resistance to the elliptical walking motion of the patient's feet on the foot supports 117. As the patient's muscles begin to tire, the RPM of the motor 110 begins to slow and less brake force is applied by the motor in order to maintain the exercise. Eventually, as the patient's muscles reach a point beyond which they are too tired to continue, the motor 110 switches from brake mode to motor mode. Thus the treatment switches from an active exercise to a passive exercise. It has been found that, like above, passive exercise of the patient's limbs awakens neural “memories” of walking in the patient's nervous system, thus rehabilitating the patient's nervous system.

While machines have been shown and described that serve the purpose of rehabilitating a person's nervous system for controlling the person's legs, the principles of the present invention apply equally to rehabilitating the nervous system for controlling a person's arm or other muscles. For example the embodiment of FIG. 1 could be easily altered to allow rotation of crank 10 by a person's arms and hands. The embodiment of FIG. 3 could be easily altered to allow elliptical rotation of a person's arms and hands. It is to be understood that the present disclosure is to be considered only as an example of the principles of the invention. This disclosure is not intended to limit the broad aspect of the invention to the illustrated embodiment.

I claim:

1. I claim an exercise bicycle for the rehabilitation of individuals who have suffered spinal cord injury wherein the bicycle is capable of transitioning the person exercising from active exercise to passive exercise.
